(19) United States
(12) Patent Application Publication
(10) Pub. No.: US 2015/0298483 A1
(43) Pub. Date: Oct. 22, 2015

(54) COUNTERFEIT-PROOF LABEL HAVING SECURITY FEATURES FOR CONSUMERS IDENTIFICATON AND VERIFICATION

(71) Applicants: Karl Peng, Novi, MI (US); Jingze He, Shenzhen (CN)

(72) Inventors: Karl Peng, Novi, MI (US); Jingze He, Shenzhen (CN)

(73) Assignee: RED HAWK EYE, LLC, Farmington Hills, MI (US)

(21) Appl. No.: 14/256,181

(22) Filed: Apr. 18, 2014

(51) Int. Cl. B42D 25/30; B42D 25/405

(52) U.S. Cl. CPC B42D 25/30; B42D 25/405

(57) ABSTRACT

A counterfeit-proof label for consumers' identification and verification with unaided eyes and without using a device or performing any additional process is provided. The counterfeit-proof label has a series of first images printed along a first moving path and a series of second image printed along a second moving path for providing coordinated and synchronized moving relationship determined by a relationship length parameter and a relationship angle parameter for continuous moves of visual effect images as the counterfeit-proof label continuously tilts with a series of angles. A security coating is applied on the counterfeit-proof label to prevent the printed.

### FIELD OF THE INVENTION

The present invention is related to a counterfeit-proof label having predetermined security features for general consumers' identification and verification and having concealed non-replicable non-reproducible images discouraging attempting at counterfeiting.

### BACKGROUND OF THE INVENTION

Counterfeiting has been an old problem for many businesses and organizations. Over the years many different technologies have been developed to find solutions to prevent counterfeiting. However, the current available anti-counterfeiting products have two major problems. One is that the anti-counterfeiting security features are not easy for consumers to use unaided eyes to distinguish the genuine labels from the counterfeiting ones. Another problem is that the anti-counterfeiting identification process is complicated so that it either requires a trained expert to perform the identification and verification for the product or needs an electronic device or through the internet to validate the authenticity of the product. These problems make the current anti-counterfeiting solution less effective and less reliable to curtain the counterfeiting practices.

Therefore, it is the objective of the invention to provide a counterfeit-proof label with the security features that can be easily and positively recognized and identified by the general consumers with their unaided eyes before they made a decision to purchase the product. Another objective of the invention is to provide a counterfeit-proof label with the security features that once these counterfeit-proof labels are printed on the labels these source images with the security features cannot be replicated and reproduced by counterfeiters. In other words, once this counterfeit-proof label is made, the original printing mage printed on the counterfeit-proof label cannot be acquired in a perfect condition without damaging the images printed on the back side of the counterfeit-proof label.

### SUMMARY OF THE INVENTION

Applicants have invented a counterfeit-proof label. This counterfeit proof label employs the detectable and predetermined security features that can be identified by the general consumers' unaided eyes to make it difficult to replicate without prior knowledge from the counterfeiters. The counterfeit-proof label is attached to the goods or documents enable the owners of the goods or documents to assure their goods or documents to be genuine. Particularly, the security features have predetermined moving paths that when this counterfeit-proof label tilted with continuous viewing angles, the visual effect images will move along predetermined moving paths with synchronized and coordinated manner.

One advantage of this invention is that the counterfeit security features are significant and can be easily identified by the general consumers' unaided eyes. These counterfeit-proof labels do not need additional devices or process to log into the company's website to verify or validate the authenticity of the goods or documents as current anti-counterfeiting methods do. The additional devices or process to verify the authenticity of the goods or documents are not only cumbersome for the consumers but also may cause the damage to the consumers because the consumers can only perform these validations or verifications after the consumers have made the purchase of the goods or accepted the documents.

Another advantage of this counterfeit-proof label is that it sets up a prohibitive barrier for the counterfeiters to replicate and reproduce the counterfeit-proof labels because the predetermined moving paths of the images employ dynamic 3D security features, once this counterfeit-proof labels are made, and cannot be replicated and reproduced with available counterfeiting methods. If a counterfeiter wants to replicate the printed image information with the security moving paths on the counterfeit-proof labels, the counterfeiter needs either to know the mathematical formula for the moving paths of the images, or to directly acquire the interlaced images printed on the back of the counterfeit-proof label. Any attempt at photocopying or scanning on the viewable images from the top of the counterfeit-proof label will not produce the same visual effect images as originally designed. Completely acquiring the interlaced images printed on the back side of the counterfeit-proof labels is extremely difficult because once the counterfeit-proof images have been printed on the flat side of the counterfeit-proof label the printing layer cannot be separated from the surface of the lenticular sheet. Even though the counterfeiter can separate the original printed interlaced images from the lenticular sheet, the images will be severely damaged or distorted hence will be useless because the requirements for precise registration of the images and for precise alignment between the images and the lenticular lenses will be lost, hence the counterfeiting attempts will fail.

Other systems, methods, features, and advantages of the present invention will be or become apparent to one with skill in the art open examination of the following drawings and detailed description, It is intended that all such additional systems, methods, features, and advantages be included within this description, be within the scope of the present invention, and be protected by the accompanying claims.

### BRIEF DESCRIPTION OF THE DRAWINGS

FIG. 1 is a top view of an enlarged counterfeit-proof label having a first image and a second image printed on the flat side of the label.

FIG. 2 is a side view of a portion of an enlarged cross-section of counterfeit-proof label showing one embodiment of the structure.

FIG. 3 is a side view of a portion of an enlarged cross-section of counterfeit-proof label with visual effect images viewable from a viewing point of a viewer.

FIG. 4 is a side view of a portion of an alternative construction of an enlarged counterfeit-proof label showing alternative embodiment of construction.

FIG. 5 is a side view of a portion of another alternative construction of an enlarged counterfeit-proof label showing another embodiment of construction.

FIG. 6 is a top plan view of a portion of the enlarged the counterfeit-proof label printed with first image and a second image showing the images moving along the predetermined moving paths and the relationship between the images.

FIG. 7 is a side view of a portion of the counterfeit-proof label having the counterfeit-proof label tilted a small angle and showing the visual effect images from the viewing point of a viewer.

FIG. 8 is a side view of a portion of the counterfeit-proof label having the counterfeit-proof label tilted another small angle and showing the visual effect images from the viewing point of a viewer.

FIG. 9 is a side view of a portion of the enlarged lenticule of a counterfeit-proof label with the images printed on the flat side of the lenticule showing plurality of the printing regions.

FIG. 10 is a top view of a portion of the enlarged lenticule of the counterfeit-proof label, showing plurality of the printing regions.

FIG. 11 is a top plan view of a portion of the enlarged section of a region of a lenticule of the counterfeit-proof label, showing further divided plurality of printing sub-regions with plurality of rows and columns.

### DETAILED DESCRIPTION OF THE PREFERRED EMBODIMENTS

The embodiments and aspects of the present invention will be described to illustrate the structures and constructions and processes, which are the examples rather than the limitations for the claims of the present invention. Therefore, in addition to the preferred embodiments of the specifications, the present invention can be widely applied in other embodiments.

In the preferred embodiment, the present invention is described in connection with a counterfeit-proof label having counterfeit-proof security features that create very prohibitive barriers to be replicated or reproduced by counterfeiters and that can be easily recognized and identified by the general consumers with unaided eyes without using any additional devices or having additional identification or verification process. The material for the invented counterfeit-proof label is made of plastics, glass, or any material that the light can travel through the material into from one side and out from another side. The preferred thickness of the counterfeit-proof label is between 0.02 to 1.8 mm with a frequency of between 1 to 52 lenticules per mm.

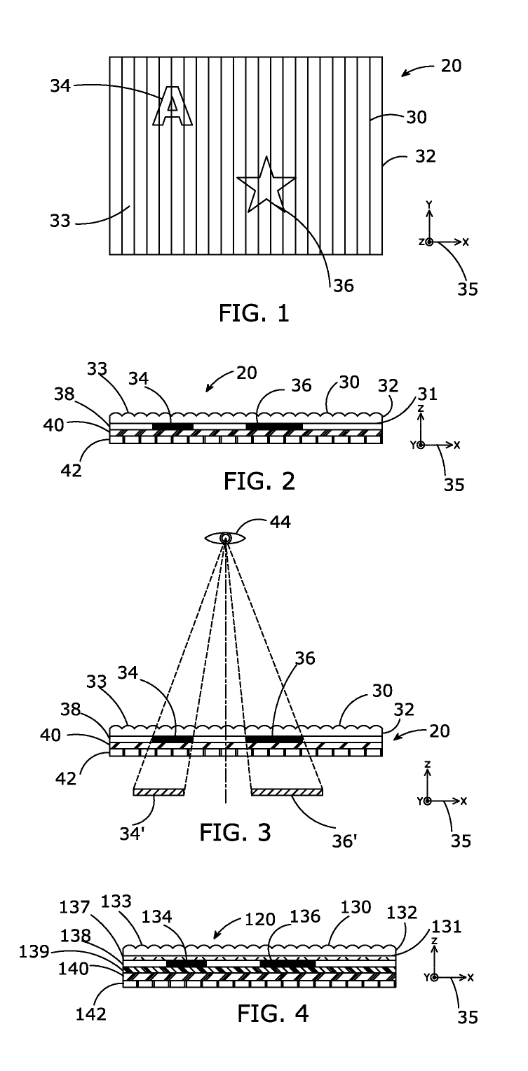

With reference to FIGS. 1 and 2, a counterfeit-proof label 20 of the preferred embodiment has a lenticular sheet 30 with the length and the width substantially greater than the thickness and having a plurality of lenticular lenses 32 on one side and a flat side 31 opposite the side of lenticular lenses 32. Counterfeit-proof label 20 is associated with at least one first image 34 and at least one second image 36 in an image layer 38 to provide illusions. First image 34 and second image 36 may be printed on flat side 31 using conventional lenticular lens printing methods which require the precise registration of first image 34 and second image 36, with respect to lenticule 33 on lenticular sheet 30 to produce the images to be viewable though lenticular lenses 32 with the intended visual effects. Permanent adhesive 40, preferably a pressure sensitive adhesive, is applied between image layer 38 and a release liner 42 which can be used to carry counterfeit-proof label 20 and can be separated and peeled off so that adhesive 40 can permanently adhere counterfeit-proof label 20 to an intended surface of an article for counterfeit-proof purposes. Any attempt at separating the printed image layer 38 from the surface of the article will result in damage on the precise registration of the printed first image 34 and second image 36 in the image layer 38. In an application that counterfeit-proof label 20 is used as a hanging tag attached to an article, adhesive 40 and release liner 42 can be permanently adhered together.

With reference FIGS. 1, 2 and 3, from the top plan view showing in the X-Y plane of a Cartesian coordinate system 35, first image 34 and second image 36 are printed in the image layer 38 on flat side 31 opposite lenticular lenses 32. From the viewing point of a viewer 44 depicted in FIG. 3, first visual effect mages 34′ corresponding to first image 34 and second visual effect image 36′ corresponding to second image 36 can be viewable from the top of counterfeit-proof label 20.

As desired, first image 34 and second image 36 may be associated with any configurations on the counterfeit-proof label 20. First image 34 and second image 36 may be any combinations of graphics, text, or other visual information. The visual effect images associated with first image 34 and second image 36 are indicated in FIG. 3 viewed as a first visual effect image 34′ and a second visual effect image 36′ respectively from the viewing point of the viewer 44. As used herein, “visual effect image” means an image that creates illusions such as “flips”, “3-D” or stereographic, full motion video, “morphing”, and zooming. A “flip” represents an abrupt change from one view image to another different image when a viewer tilts the label. “3-D” effects produce an illusion of depth for an object being viewed. Full motion video produces a sense of a movement of an object being viewed as the viewing angle changes. “Morphing” produces an illusion of a metamorphosis (transition) from one image to another as the viewing angle changes. Zooming presents a size change of an object being viewed, the object appearing to move either closer to, or away from the viewer as the viewing angle changes.

In an alternative embodiment depicted in FIG. 4, a counterfeit-proof label 120 has a lenticular sheet 130 with a plurality of lenticular lenses 132 on one side and a flat side 131 opposite the side with lenticular lenses 132, permanent adhesive 137 applied between the flat side 131 of counterfeit-proof label 120 and an image layer 138 including at least one first image 134 and at least one second image 136, a label stock 139, adhesive 140, and a release liner 142. First image 134 and second image 136 are printed on the surface of label stock 139 which is precisely aligned with lenticule 133 of lenticular sheet 130 in a conventional manner to provide the intended visual effect images 34′ and 36′ as shown in FIG. 3.

Label stock 139 may be any material or combination materials, including but not limited to paper, plastic, metal foil, or another layer of coating applied on the surface of image layer 138. Permanent adhesive 137 secures the image layer 138 with flat side 131 of lenticular sheet 130. Adhesive 140 is applied between label stock 139 and release liner 142. Adhesive 140 is preferably pressure sensitive adhesive, but may be any adhesive as the application requires. Release liner 142 is preferably a silicon coated liner, but may be any suitable carrier liner that can be separated or peeled off to allow counterfeit-proof label 120 to be adhered to intended surface of an article for counterfeit-proof purpose. In an application that counterfeit-proof label 120 is used as a hanging tag attached to an article, adhesive 140 and release liner 142 can be absent.

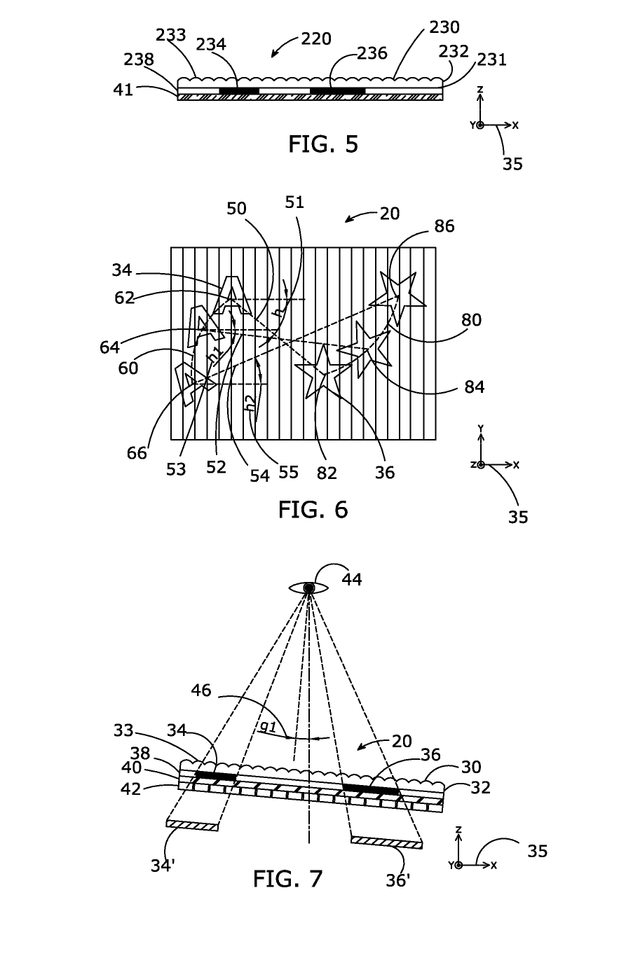

Yet in another alternative embodiment depicted in FIG. 5, a counterfeit-proof label 220 has a lenticular sheet 230 with a plurality of lenticular lenses 232 on one side and a flat side 231 opposite the side with lenticular lenses 232, an image layer 238 including at least one first image 234 and at least one second image 236 printed on the flat side, a security layer 241 which is applied on image layer 238 and which may be a thin layer of coating or any material for concealing the printed digital image information in image layer 238 and is employed to prevent first image 234 and second image 236 from being replicated or reproduced. First image 234 and second image 236 are printed on flat side 231 of lenticular sheet 230. In an application that counterfeit-proof label 220 is employed as a hanging tag with a product, security layer 241 may be applied on the image layer 238 for being used for concealing first image 234 and second image 236 printed on the flat side 231 of the counterfeit-proof label 20.

With reference FIG. 6, a predetermined first moving path 60 showing in a hidden line for printing a series of first image 34 along first moving path 60 and a predetermined second moving path 80 showing in a hidden line for printing a series of second image 36 along second moving path 80 are created but will not be printed and visible to the viewer 44 on the counterfeit-proof label 20. A predetermined relationship length parameter 50 which is indicated by a hidden line and a predetermined relationship angle parameter 51 indicating the angle for relationship length parameter 50 with the X-axis in the X-Y plane of Cartesian coordinate system 35 are created to provide coordinated and synchronized viewing moving relationship between first moving path 60 and second moving path 80. Predetermined first moving path 60, second moving path 80, relationship length parameter 50, and relationship angle parameter 51 can be mathematically described and are selected parameters for counterfeit-proof label 20 for counterfeit-proof purposes. By employing relationship length parameter 50 and relationship angle parameter 51, the complexity of the synchronized and coordinated moves is significantly increased so as to make the replication and reproduction of said counterfeit-proof label 20 extremely untenable.

In the beginning of the process, first image 34 is printed on flat side 31 of lenticular sheet 30 at location 62 on first moving path 60. When counterfeit-proof label 20 is tilted with a small tilting angle 46 as g1 degrees about Y-axis of Cartesian coordinate system 35 depicted in FIG. 7, first image 34 is now printed at location 64 on first moving path 60.

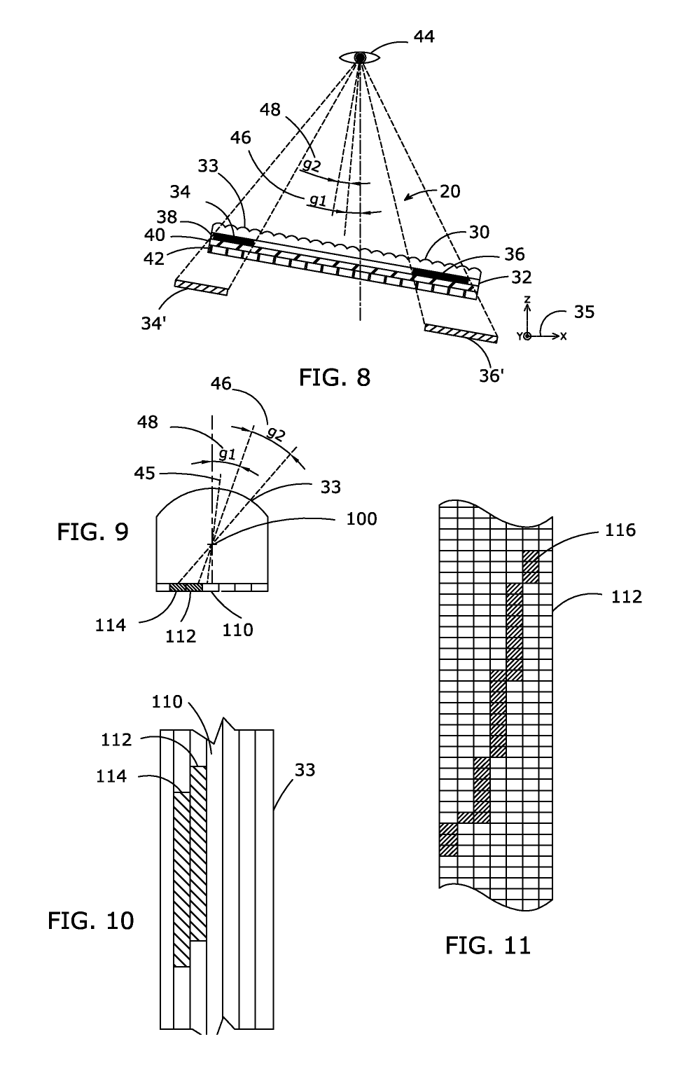

When the counterfeit-proof label 20 is tilted with another small tilting angle 48 as g2 degrees about Y-axis of Cartesian coordinate system 35 depicted in FIG. 8, first image 34 is now printed at location 66 on first moving path 60.

Now first moving path 60 is divided into a series of small segments corresponding to a series of small tilting angles about Y-axis in Cartesian coordinate system 35. A series of first image 34 printed on flat side 31 of lenticular sheet 30 along predetermined first moving path 60, visual effective image 34′ will be viewable by viewer 44 as moving from location 62 to location 66 as if it is a continuously moving video when the series of tilting angles become very small with each small tilting angle corresponding to each small segment.

After first moving path 60 is determined, second moving path 80 then can be determined by image relationship length parameter 50 and image relationship angle parameter 51 at each location with one end of relationship length parameter 50 moving along first path 60 and the other end moving along second path 80. Image relation length parameter 50 and image relationship angle parameter 51 are determined by a mathematical formula when the images are created. As a result, as first image 34 moves to the location 64 from location 62 along first moving path 60, the length of predetermined relationship length parameter 50 changes and the angles of relationship angle parameter 51 also changes to h1 degrees respectively according to the mathematical formula, as the second image 36 moves to location 84 location 82 along the second moving path 80.

Similarly, when the first image 34 is moved to location 66 from location 64 along the predetermined first moving path 60, the second image 36 is moved to location 86 from location 84 along predetermined second moving path 80, relationship length parameter 50 between first image 34 and second image 36 changes to a length 54 and the relationship angle 51 angle changes to angle 55 with the degrees of h2. Because the curvature of lenticule 33 only first image 34 and second image 36 can be viewable by the viewer 44 within the viewing angle g2 as first visual effect image 34′ and second visual effect image 36′ respectively as depicted in FIG. 8.

Now with the series of first image 34 printed along first moving path 60 with each of which corresponds to the series of small tilting angles and the series of second image 36 printed along second moving path 80 with each of which corresponds to the series of small tilting angles, from the viewing point of viewer 44 the series of first image 34 will be viewed as series of first visual effect image 34′ moving along first moving path 60 from location 62 to 66 and second image 36 will be viewed as series of visual effect image 36′ moving along second moving path 80 from location 82 to 86 as video effect as counterfeit-proof label 20 continuously tilts with a series of small tilting angles about the Y-axis of Cartesian coordinate system 35 depicted in FIGS. 3, 7, and 8. The moves of first image 34 along first moving path 60 and the moves of second image 36 along second moving path 80 are in a synchronized and coordinated manner determined by the predetermined relationship mathematical formula for relationship length parameter 50 and relationship angle parameter 51. The characteristics of synchronized and coordinated moves of first visual effect image 34′ and second visual effect image 36′ as a moving video can be easily recognized and identified by viewer 44 without any added device or additional process. Series of first image 34 and series of the second image 36 are required to be precisely created and printed on flat side 31 of lenticular sheet 30 and precisely aligned with lenticular lenses 32 of counterfeit-proof label 20 for providing perfect visual effect images as intended. Any slight misalignment of the position of the images will result in a substantial difference on the synchronized and coordinated moves of first visual effect image 34′ and the moves of second visual effect image 36′ hence viewer 44 can identify it is a counterfeit label.

FIG. 9 illustrates a side view and FIG. 10 illustrates a top view of a section of an enlarged lenticule 33 having an optical center 100 and a curvature to provide visual effect image so that as counterfeit-proof label 20 tilts at different tilting angle 46 and tilting angle 48 from angle 45, the rays from image 34 will travel though optical center 100 to reach the eyes of viewer 44. Lenticule 33 divides the image layer 38 into a plurality of printing regions parallel to the longitudinal direction of lenticule 33. Those printing regions will be used to print the images created for providing visual effect images that are only be viewable by viewer 44 at specified tilting angle 46 showing in FIG. 7. The printing region 110 is part of the first image 34 being printed on flat side 31 only being viewable by viewer 44 at location 62 showing in FIG. 6. In this situation, printing region 110 is blank because image 34 is out of the viewing angle of viewer 44. Image region 112 is part of first image 34 printed on flat side 31 only being viewable under viewer 44 at location 64 shown in FIG. 6 when the counterfeit-proof label 20 is tilted at tilting angle 46 as g1 degrees (FIG. 7) corresponding to the location 64. Image region 113 is part of first image 34 printed on flat side 31 only being viewable under viewer 44 at location 66 showing in FIG. 6 when the counterfeit-proof label 20 is tilted at angle 48 as g2 degrees (FIG. 8) corresponding to the location 66. FIG. 11 illustrates an enlarged section of the printing region 112. The region 112 is further divided into a plurality of rows and a plurality of columns so as to have plurality of sub-regions 116. According to the requirements of the interlaced images to provide visual effect images, selected sub-regions of 116 are printed with part of image 34 viewable by viewer 44. Selected sub-regions 116 may be printed with different colors as counterfeit-proof label 20 requires. Each par of sub-regions is printed with part of first image 34 corresponding to part of visual effect image 34′.

The above descriptions are those of the preferred embodiments of the invention. Various altercations and changes can be made without departing from the spirit and broader aspect of the invention as defined in the appended claims that are to be interpreted according to the principles of the patent laws including the doctrine of equivalents. Any references to claim elements in the singular, for example, using the articles “a,” “an,” “the,” or “said,” is not to be construed as limiting the elements to the singular.

What is claimed is:

1. A counterfeit-proof label having security features for consumers' easy identification and verification comprising:
a lenticular sheet having a lenticular side with a plurality of lenticular lens and a flat side opposite side of said lenticular lens;
a series of a first image printed on said flat side of said lenticular sheet along a predetermined first moving path corresponding to a series of tilting angles for providing a series of a first visual effect image;
a series of a second image printed on said flat side of said lenticular sheet along a predetermined second moving path corresponding to a series of tilting angles for providing a series of a second visual effect image;
whereby said first moving path and said second moving path corresponds to said series of said tilting angles are determined by a relationship length parameter and a relationship angle parameter for providing a moving relationship between said first image and said second image.

2. The counterfeit-proof label having security features for consumers' easy identification and verification of claim 1 wherein said first moving path is determined by a mathematical formula for proving coordinated and synchronized moves between said series of first image and said series of second image.

3. The counterfeit-proof label having security features for consumers' easy identification and verification of claim 2 wherein said mathematical formula comprises a line in the plane of said flat side of said lenticular sheet.

4. The counterfeit-proof label having security features for consumers' easy identification and verification of claim 1 wherein a security coating is applied on an image layer in which said series of first image and said series of second image are printed on said flat side of said lenticular sheet for concealing the digital image information of said series of first image and said series of second image and for preventing said image information from being replicated and reproduced.

5. The counterfeit-proof label having security features for consumers' easy identification and verification of claim 4 wherein an image region corresponding to a lenticle is divided into a plurality of rows and a plurality of columns with a plurality of sub-regions for printing selected said sub-regions with said series of first image along said first moving path and said series of second image along said second moving path corresponding to said series of tilting angles viewable as said series of first visual effect image and said series of second visual effect image.

6. The counterfeit-proof label having security features for consumers' easy identification and verification of claim 5 wherein said sub-regions are selected to be printed with a plurality of colors.

7. The counterfeit-proof label having security features for consumers' easy identification and verification of claim 1 wherein adhesive is applied between said image layer and a carrier liner for adhering said counterfeit-proof label to an intended surface of an article.

8. The counterfeit-proof label having security features for consumers' easy identification and verification of claim 7 wherein said adhesive and said carrier liner are permanently adhered together for preventing image information printed on said flat side from being replicated.

9. The counterfeit-proof label having security features for consumers' easy identification and verification of claim 1 wherein said lenticular lenses has a frequency of from 1 to 52 lenticules per mm.

10. A counterfeit-proof label having security features for consumers' easy identification and verification comprising:
a lenticular sheet having a lenticular side with a plurality of lenticular lens and a flat side opposite said lenticular lens;
a label stock having a series of a first image printed on said label stock in a predetermined first moving path corresponding to a series of tilting angles for providing a series of a first visual effect image viewable by a viewer and having a series of a second image printed on said label stock in a predetermined second moving path corresponding to a series of tilting angles for providing a series of a second visual effect image viewable by said viewer;
whereby said label stock is secured to said flat side of said lenticular sheet with permanent adhesive.

11. The counterfeit-proof label having security features for consumers' easy identification and verification of claim 10 where in said first moving path and said second moving path corresponds to said series of said tilting angles being determined by a relationship length parameter and a relationship angle parameter for providing a relationship between said first image and said second image.

12. The counterfeit-proof label having security features for consumers' easy identification and verification of claim 10 wherein said first moving path is determined by a mathematical formula for proving coordinated and synchronized moves between said series of first image and said series of second image for said viewer.

13. The counterfeit-proof label having security features for consumers' easy identification and verification of claim 10 wherein a release liner is secured to said label stock with pressure sensitive adhesive for preventing image information of series of said first image and said series of second image printed on said flat side from being replicated.

14. The counterfeit-proof label having security features for consumers' easy identification and verification of claim 1 wherein said lenticular lenses has a frequency of from 1 to 52 lenticules per mm.

15. A method of making a counterfeit-proof label for consumers' easy identification and verification comprising the steps of:
creating a series of first image in a predetermined first moving path in accordance with a series tilting angles viewable for a viewer;
selecting a mathematical formula for establishing a relationship length parameter and a relationship angle parameter to create an image relationship for said series of first image and a series of second image corresponding to a series of tilting angles for providing coordinated and synchronized moves between said series of first image and said series of second image;
creating said series of second image in a second moving path corresponding to the relationship determined by said relationship length parameter and said relationship angle parameter;
printing said series of first image and said series of second image on a flat side of said counterfeit-proof label.

16. The method of making a counterfeit-proof label for consumers' easy identification and verification of claim 15 further comprising applying a security layer on the surface of a image layer in which said series of first image and said second image are printed for concealing image information and prevent printed said series of first image and said series of second image from being replicated and reproduced.

17. The method of making a counterfeit-proof label for consumers' easy identification and verification of claim 15 further comprising applying pressure sensitive adhesive between the surface of said security layer and a release liner for securing said pressure sensitive adhesive to a surface of an article by peeling off said release liner.
